(19) United States
(12) Patent Application Publication
(10) Pub. No.: US 2021/0168633 A1
(43) Pub. Date: Jun. 3, 2021

(54) Methods Circuits Devices Systems and Functionally Associated Computer Executable Code to Support Data Services from a Radio Access Network of a Wireless Communication Network to a Wireless Device Communicatively Coupled to the Communication Network

(71) Applicant: SAGUNA NETWORKS LTD., Yokneam Illit (IL)

(72) Inventors: Barak Enat, Haifa (IL); Lior Fite, Zurit (IL)

(21) Appl. No.: 16/591,560

(22) Filed: Oct. 2, 2019

Related U.S. Application Data
(63) Continuation-in-part of application No. 16/442,520, filed on Jun. 16, 2019.
Application No. 16/442,520 is a continuation of application No. 15/434,259, filed on Feb. 16, 2017, now abandoned.
Application No. 15/434,259 is a continuation-in-part of application No. 15/434,536, filed on Feb. 16, 2017, now abandoned.
(60) Provisional application No. 62/739,886, filed on Oct. 2, 2018.
(60) Provisional application No. 62/295,521, filed on Feb. 16, 2016.
(60) Provisional application No. 62/295,522, filed on Feb. 16, 2016.

(51) Int. Cl. H04W 24/08; H04W 36/12; H04L 12/26; H04M 15/00; H04W 4/24

(52) U.S. Cl. CPC H04W 24/08; H04W 36/12; H04L 43/04; H04L 65/1066; H04M 15/55; H04M 15/61; H04W 4/24; H04M 15/48

(57) ABSTRACT

The present application discloses methods, circuits, devices, systems and functionally associated computer executable code to support data services provided by one or more edge data service providers/applications running on edge computing resources, integral or otherwise functionally associated with a Radio Access Network (RAN) segment of a wireless communication network, to one or more wireless communication devices communicatively coupled to the wireless communication network through the RAN segment. Embodiments of the present invention include a wireless communication network comprising with at least one network core having one or more network elements to perform each of one or more network management functions, including to managing wireless communication device (User Equipment—UE) related information. The network also includes at least one network edge segment which includes: (a) one or more wireless access nodes to which a UE associated with the network can communicatively couple; and (b) at least one edge computing resource to provide one or more edge data services to a communicatively coupled UE. A network edge gateway between said network core and the network edge segment may include a tokenizer to generate UE specific tokens and to send the tokens to the at least one edge computing resource.

### PRIORITY CLAIMS

The present application claims the benefit of U.S. Provisional Patent Application 62/404,228 filed Oct. 2, 2019. The present invention is a continuation in part of U.S. patent application of U.S. patent application Ser. No. 16/442,520 filed Jun. 16, 2019, which in turn is a continuation of U.S. patent application Ser. No. 15/434,259 filed Feb. 16, 2017. The present invention is a continuation in part of U.S. patent application Ser. No. 15/434,536 filed Feb. 16, 2017. U.S. patent application Ser. Nos. 15/434,259 and 15/434,536 both claim the benefit of U.S. Provisional Patent Applications 62/295,522 and 62/295,521 both filed Feb. 16, 2016. The disclosures of each of the abovementioned applications is hereby incorporated herein by reference in its entirety.

### FIELD OF THE INVENTION

The present invention generally relates to the field of wireless communication and wireless data network architecture. More specifically, the present invention relates to methods, circuits, devices, systems and functionally associated computer executable code to support data services provided by one or more edge data service providers/applications running on edge computing resources, integral or otherwise functionally associated with a Radio Access Network (RAN) segment of a wireless communication network, to one or more wireless communication devices communicatively coupled to the wireless communication network through the RAN segment.

### BACKGROUND

Since 2009, when for the first time the volume of data traffic over mobile network exceeded that of voice traffic, mobile data has more or less tripled each year in volume, thus taking over more and more of the mobile traffic in volume. In order to meet demand for low latency data services, Edge computing and Edge computing clouds are becoming part of the mobile network architecture standard.

Edge Computing is a new concept in Software Defined Networking and Virtualization Technology. The edge computing paradigm is focused on moving compute and storage to the edge of the network and connecting UEs to applications residing on these edge platformers or on enterprise networks, without the need to pass the traffic through the network core. Edge Computing solutions, be it Mobile Edge Computing (MEC), Open Edge Computing (OEC), Fog, CORD and Open CORD or any other concept of Software Defined Networking and Virtualization Technology at the edge, present an opportunity to provide new and exciting services to end users, including those associated with enterprise clouds.

Mobile communication network Edge computing enables a variety of services, including location based services. Additionally, as new ways of determining or estimating, with good precision, a location of each wireless communication device communicatively coupled to the network becomes possible, new opportunities to provide a wider variety of business oriented location based services are emerging.

There are different scenarios and use cases in which a communication network owner, be it a mobile operator, an enterprise or other, would like to create a service granularity for different groups of users at the edge of the network, enabling it to differentiate not only which services are available/accessible for each user, but also add additional accessibility features based for example on location, and also group UEs for different services. To support such a capability, the identity of each UE needs to be available in the RAN, but the 3GPP standardization prohibits sensitive user information such as IMEI, IMSI, MSISDN numbers to be passed down the mobile network beyond the EPC, thus this information can't be used in the RAN for UE identification.

Accordingly, there is a need for improved methods, circuits, device and systems for supporting edge data services. Accordingly, there is a need for improved methods, circuits, device and systems for providing an edge data service with identifying information about a mobile communication device (UE) connected to the network edge serviced by the edge data service.

### SUMMARY OF INVENTION

The present invention includes methods, circuits, devices, systems and functionally associated computer executable code to support data services provided by one or more edge data service providers/applications running on edge computing resources, integral or otherwise functionally associated with a Radio Access Network (RAN) segment of a wireless communication network, to one or more wireless communication devices communicatively coupled to the wireless communication network through the RAN segment.

Embodiments of the present invention include methods of enabling a consistent user identity for UE's inside the RAN of mobile networks regardless of the transient properties of the UE's (such as IP and teid) and without revealing the UE's IMSI, MSISDN and IMEI information inside the RAN. Embodiments of the present invention overcome a UE identification limitation resulting from the 3GPP standardization prohibition on sensitive user information, such as IMEI, IMSI, MSISDN numbers, to be passed down the mobile network beyond the EPC. This this information can't be used in the RAN for UE identification, the present invention uses tokenization to convey various UE related information to the RAN and edge data services running therein.

Embodiments of the present invention enable a Network Operator to create a service granularity that can differentiate not only which services are available/accessible for each user/UE, but also add additional accessibility features based for example on location, and group UE's for access to/from specific edge hosted or otherwise related services and capabilities.

Embodiments of the present invention define a universal traceable identifier (UTID) which may be a hash string that may be generated by an edge gateway (EG), or a tokenizer contained therein, using a UE's personal information (IMSI, MSISDN, IMEI etc.) and some secret key. The UTIDs may be passed from the EG to different edge servers (ESs) located within the network edge environment of a RAN or RAN segment. The UTID may be passed as part of a data token generated by the EG tokenizer. UTIDs may be used by ES's as required to identify specific users/UE's and to configure edge connectivity/routing and edge data services for each specific UE based on the specific UE's user group affiliations and or based on the UE's unique identity.

According to further embodiments, each EG may maintain a table which associates different UE with different user permission groups (UPG's). A UPG, generated by an EG according to embodiments, may be a set of integers, representing the UE's permission group memberships/affiliations. The ESs, or data routing modules associated therewith, may use the different UPG values to steer/route specific data traffic passing through. The ES may perform UE data routing according to routing rules within a routing rule table accessible to the ES, and which table correlates UE user groups with routing policies for data from UE's associated with different user groups.

According to embodiments of the present invention, as exchange of information between the ES and the EG, may be triggered upon detection of a new Radio Access Bearer (RAB) issued to a UE connecting to the wireless communication network. The exchange may include a UE token query from the SE using the RAB identifier of the connecting UE. The exchange may also include a response by the EG including respective UTID and UPG information for the connecting UE associated with the RAB identifier, and optionally one or more IP addresses assigned to the UE by a network element.

Embodiments of the present invention may include a communication network having at least one network core with one or more network elements to perform each of one or more network management functions, including to management of wireless communication device (User Equipment—UE) related information. The exemplary network may also include at least one network edge, also known as computing edge, segment integral of otherwise functionally associated with a Radio Access Network portion of said communication network. The edge segment may include: (a) one or more wireless access nodes to which a UE associated with the network can communicatively couple; and (b) at least one edge computing resource to provide one or more edge data services to a communicatively coupled UE. A network edge gateway between said network core and said network edge segment may include a tokenizer to generate, using UE specific information, UE specific tokens and to send the UE specific tokens to the at least one edge computing resource.

A communication network according to embodiments of the present invention may include at least one edge computing resource with an edge server to manage data routing between a UE connected to said wireless access nodes, one or more edge data services and said network core. The edge server may adjust data routing for a given UE connected to an associated wireless network access node responsive to user permissions group (UPG) data contained in a token associated with the UE. The edge server may further include a data routing module which routes data for a given UE connected to an associated wireless network access node, either to said network core or to specific edge data services, responsive to user permissions group (UPG) data contained in a token associated with the given UE.

According to further embodiments, the edge server may include: (a) a Radio Access Bearer (RAB) detector which captures a RAB identifier associated with a UE that connected to a wireless network access node; and (b) a query generator to send a UE token request said edge gateway based on the captured RAB identifier to. The edge server may also include an Edge Data Service Manager to activate, configure or deny edge data services for a given UE connected to a wireless access node of said network based either on UPG data or a unique identifier of the UE extracted from a token associated with the UE. The Edge Data Service Manager may be adapted to pass the UPG and UE identifier data for the given UE to one or more edge data services. According to embodiments, one or more edge data services may be adapted to adjust services provided to a given UE based on UPG or on UE identifier data received for the given UE. The

According to embodiments, a UE specific token for a given UE includes, or is otherwise associated with, an universal traceable identifier (UTID) which enables an edge data service running on the at least one edge computing resource to determine identification information related to an account of the given UE. A UE specific token for a given UE may include user permission group (UPG) information relating to an account associated with the given UE and is usable by an edge data service running on the at least one edge computing resource to activate, configure or deny data service to the given UE.

According to embodiments, a tokenizer generates UE specific token for a given UE when the UE communicatively couples to a wireless access node of a network edge segment and a Radio Access Bearer (RAB) is initiated or otherwise assigned to the UE. The tokenizer may generate a token responsive to receiving a query from an edge server, wherein the query may include a Fully Qualified Tunnel Endpoint Identifier (F-TEID) allocated to the given UE upon RAB initiation. According to embodiments, the UE specific token may include identification of one or more public IP addressed allocated to the given EU by a network core element.

According to embodiments, two or more edge data services may use a UE specific token associated with a given UE to coordinate services provided to the given UE. Of the the edge data services may be a group attributes data source, such as a data table which stores data routing policies to be applied data from and to UE's associated with specific user groups.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram illustrating an exemplary cellular communication network according to embodiments of the present invention including edge computational platforms with computing resources at the network edge segments and an Edge Gateway with Tokenizer between the core of the network and the network edge segments, wherein one of the edge segments includes enterprise (cloud) computing resources;

FIG. 2A is a functional block level network diagram illustrating an exemplary communication network according to embodiments of the present invention including edge computational platforms in the form of MEC Hosts at several different kinds the network edge segments, include Enterprise Sites, Hub Sites and CRAN Sites, serviced by a single Edge Gateway with UTID & UPG Tokenizer Server located between the network core and the network edge segments;

FIG. 2B is a simplified functional block diagram version of FIG. 2A further indicating data and signaling paths between various network core elements, an edge gateway, an edge server with build in edge computing resources, Edge Data Routing, Edge Data Services and eNB's according to exemplary embodiments of the present invention;

FIG. 3 is an information flow diagram illustrating an exchange of information between an edge server according to embodiments of the present invention and an edge gateway according to embodiments of the present invention, wherein the edge server upon detection of a new RAB queries the edge gateway for identification information relating to the UE to which the new RAB was assigned and the edge gateway responds with a UE specific token which includes a UTID, UPG and IP addresses associated with the EU;

FIG. 4A is functional block diagram including functional block of an exemplary edge gate according to embodiments of the present invention;

FIG. 4B is a functional block diagram of including functional block of an exemplary edge server according to embodiments of the present invention;

FIG. 5 is a functional block diagram of an exemplary network according to embodiments of the present invention with redundancy built in both the network core and network edge segments using port mirroring and switching.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE FIGURES

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid-state memory, magnetic tape, a removable computer diskette, a random access memory (RAM), a read-only memory (ROM), any composition and/or architecture of semiconductor based Non-Volatile Memory (NVM), any composition and/or architecture of biologically based Non-Volatile Memory (NVM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other functionally suitable components may be used.

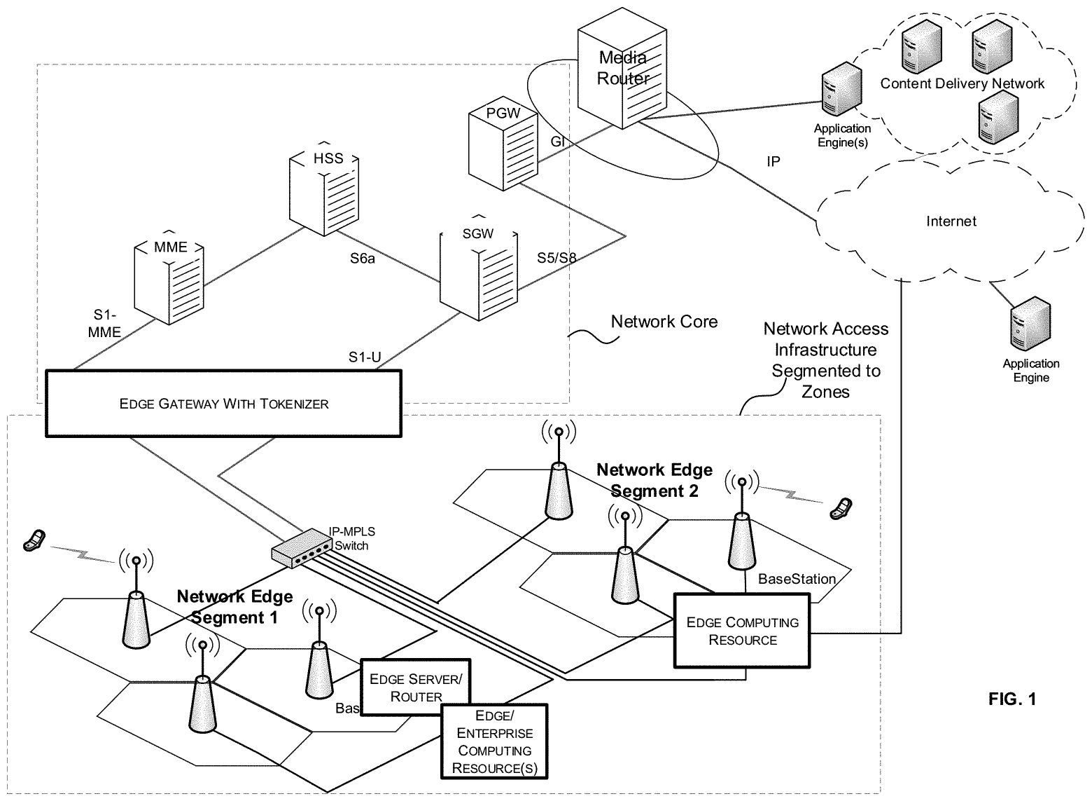

Turning now to FIG. 1, there is shown a diagram illustrating an exemplary cellular communication network according to embodiments of the present invention including edge computational platforms with computing resources at the network edge segments and an Edge Gateway (EG) with Tokenizer between the core of the network and the network edge segments, wherein one of the edge segments includes enterprise (cloud) computing resources. Also shown is an edge server with edge data routing. As describer throughout this application, edge data service and edge routing, for UE's connecting to respective edge segments is at least partially based on UE identification and or UE group affiliation information received, optionally in the form of a UE specific token, from the edge gateway.

UTID's for each UE may be pre-registered on the EG and one or more servers on the Edge. Alternatively, the UTID's may be encoded to securely encapsulate in a secure manner respective UE identification information and the one or more servers may be programmed to extract the encapsulate identification information.

User Permission Group (UGP) information for each UE may be generated based on a coding scheme pre-agreed between the EG and SE, and the UGP information may be bundled with the UTID in a UE specific token.

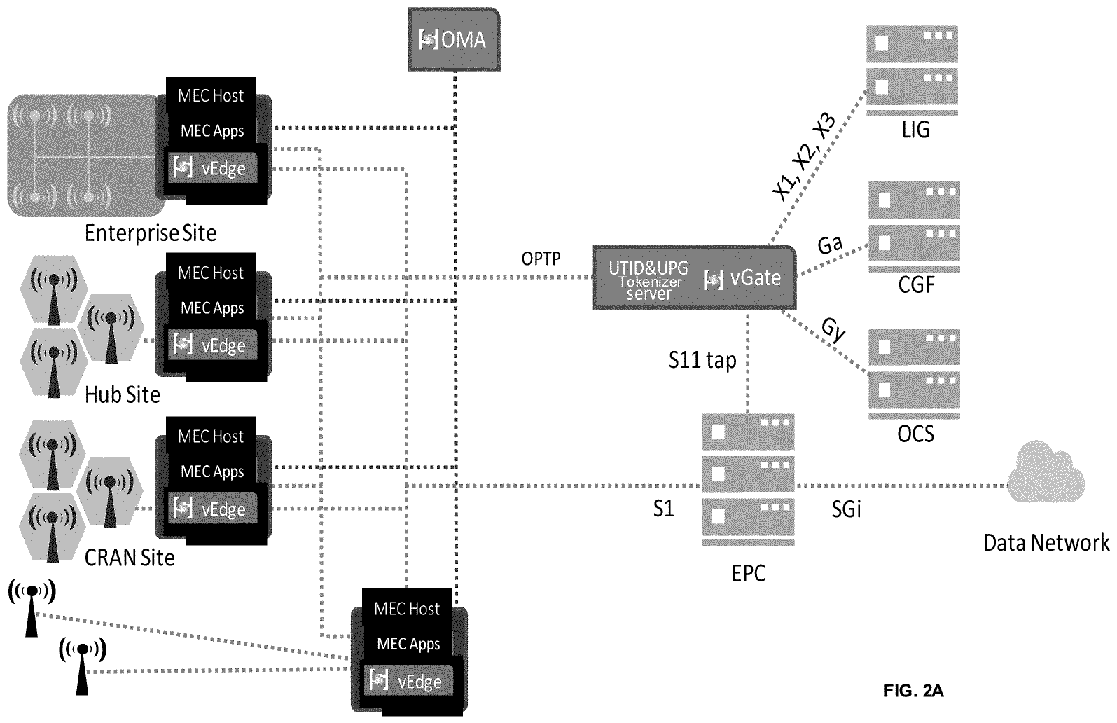

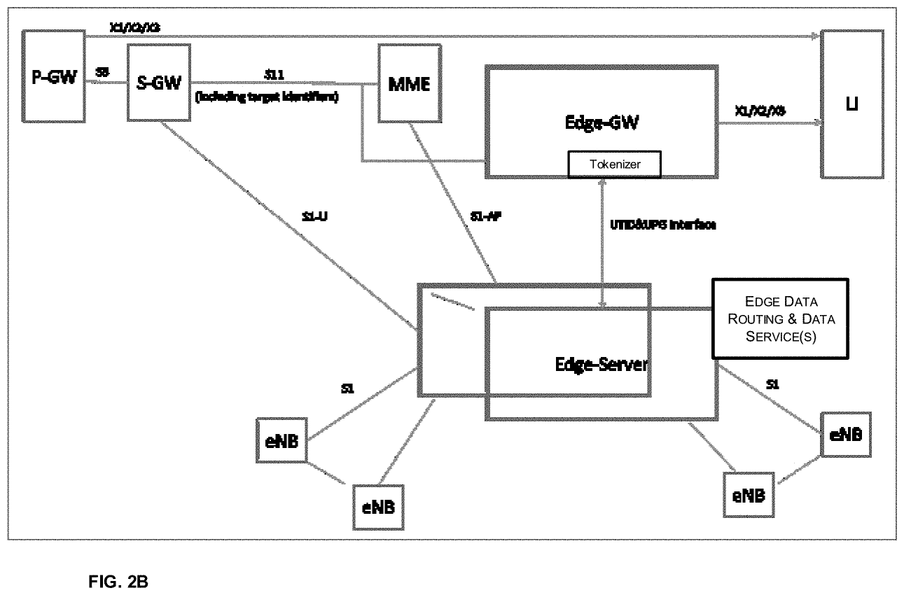

Turning now to FIG. 2A, there is shown a functional block level network diagram illustrating an exemplary communication network according to embodiments of the present invention including edge computational platforms in the form of MEC Hosts at several different kinds the network edge segments, include Enterprise Sites, Hub Sites and CRAN Sites, serviced by a single Edge Gateway with UTID & UPG Tokenizer Server located between the network core and the network edge segments. FIG. 2B is a simplified functional block diagram version of FIG. 2A further indicating data and signaling paths between various network core elements, an edge gateway, an edge server with build in edge computing resources, Edge Data Routing, Edge Data Services and eNB's according to exemplary embodiments of the present invention;

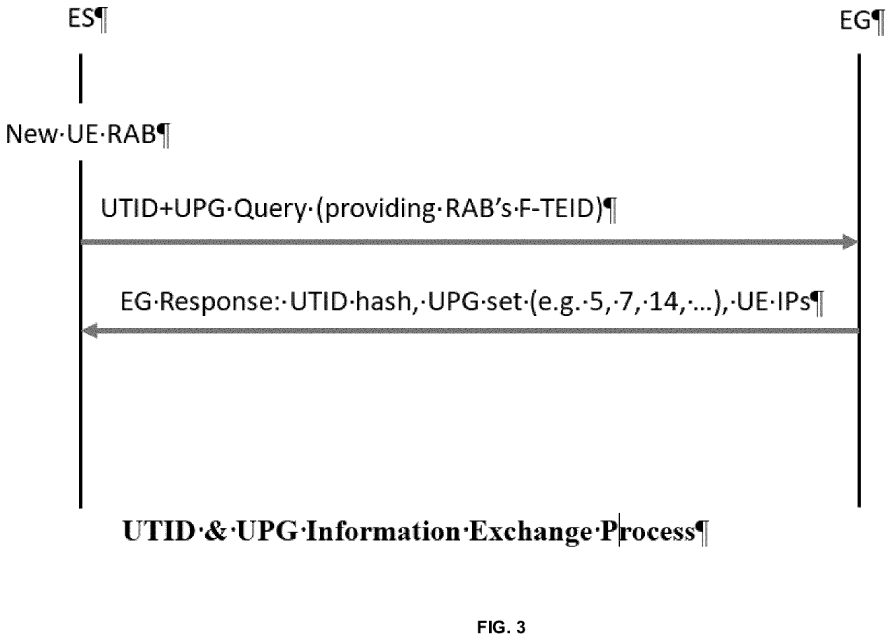

The information flow between edge gateway and edge data and routing services running on edge computing resources, collectively referable to as edge server, can be better understood in reference to FIG. 3 which is information flow diagram illustrating an exchange of information between an edge server according to embodiments of the present invention and an edge gateway according to embodiments of the present invention. The edge server upon detection of a new RAB queries the edge gateway for identification information relating to the UE to which the new RAB was assigned and the edge gateway responds with a UE specific token which includes a UTID, UPG and IP addresses associated with the EU.

This UTID, which is a hash string that may is generated by the EG from the UE personal information (IMSI, MSISDN, IMEI etc.) and some secret/shared key. The UTIDs may be passed from the EG to the different ESs. UTIDs may be used by ESs as required to identify specific users. Also passed back to the SE is a UE UPG which is a set of integers, representing the UE's permission group memberships or affiliations. The ESs may use the different UPGs to steer specific traffic passing through the edge segment according to the UE's UPG policies, which policies may be saved on a table integral or otherwise associated with the SE.

There are variant of the information exchange and corresponding edge server actions between embodiments of the present invention relating to: (a) general LTE networks, (b) enterprise in LTE/5G solutions; and (c) general 5G networks:

### General LTE

On the ES side, for generating queries for UTID & UPG upon detection of a new RABs, the ES may monitor the following S1-AP messages:
E-RAB setup request, according to 3GPP TS 36.413 9.1.3.1
E-RAB setup response, according to 3GPP TS 36.413 9.1.3.2
Initial Context Setup Request, according to 3GPP TS 36.413 9.1.4.1
Initial Context Setup Response, according to 3GPP TS 36.413 9.1.4.3
   With this, the ES is aware of every new RAB being created and the corresponding F-TIED of both S-GW and eNB and can generate the UPG Query towards the EG.
   On the EG side, to resolve the UPG query from the ES and provide a response, the EG may hold two main data structures for converting IMEI/IMSI/MSIDSND/APN etc. numbers to UPGs and UTIDs
   The first data structure may hold the require set of rules for converting: IMEI, MSISDN, IMSI, APN rules to→UPG
   The rules may be flexible rules including for example:

Full IMEI, IMSI, MSISDN number
IMEI, IMSI, MSISDN prefix: Max 15-digit number[wildcard*]
Example: 5476856780*
IMEI, IMSI, MSISDN range: Range_begin-Range_end
Example: 1234567890-1234567899
APN prefix: [String][wildcard*]
Example: mycompany.apn.*
APN postfix: [wildcard*][String]
Example: *mycompany.apn
UPG: A unique long integer

For operational purposes UPG numbers can be allocated in ranges, with each range for different purposes (different enterprises etc.).
The UPG returned to the ES may be a union of all individual matching results in the data structure.
The second data structure may be a dynamic data structure. The EG may build this data structure according to the following S-11 messages:
Create Session Request, According to 3GPP TS 29.274 7.2.1
Create Session Response, According to 3GPP TS 29.274 7.2.2
Create Bearer Request, According to 3GPP TS 29.274 7.2.3
Create Bearer Response, According to 3GPP TS 29.274 7.2.4
Modify Bearer Request, According to 3GPP TS 29.274 7.2.7
Modify Bearer Response, According to 3GPP TS 29.274 7.2.8
Delete Session/Bearer Request, According to 3GPP TS 29.274 7.2.9
Delete Session/Bearer Response, According to 3GPP TS 29.274 7.2.10
   Tracking the above taped 511 messages may enable the extraction of TEIDs, APNs, IMSI, MSISDN, default/dedicated bearers etc. information.
   This Dynamic data structure may have the follows format:

| | | | | |
|---|---|---|---|---|
| S-GW F-TIED | eNB F-TIED | MSISDN | IMSI | APN |

Where F-TIEDs, received from the EG during the request, are Key to the table.

The configuration of the required UPGs in the data structure of the EG and the optional traffic steering function in the ESs may be done using a well-defined API or any other way

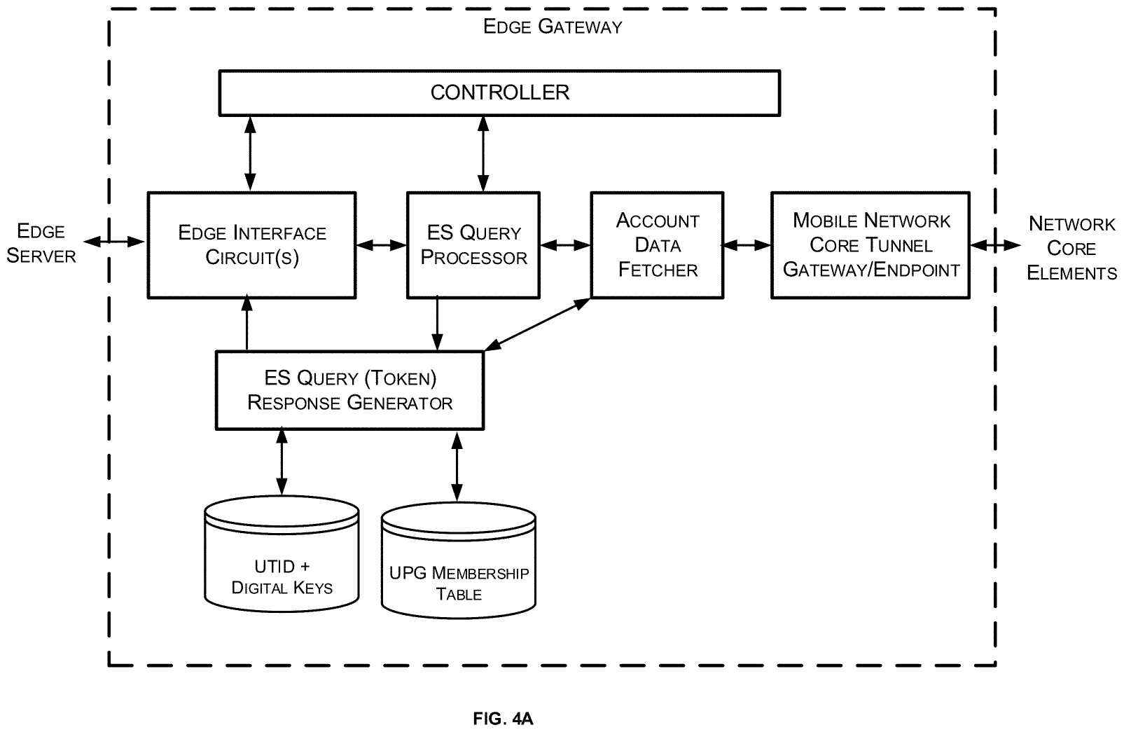

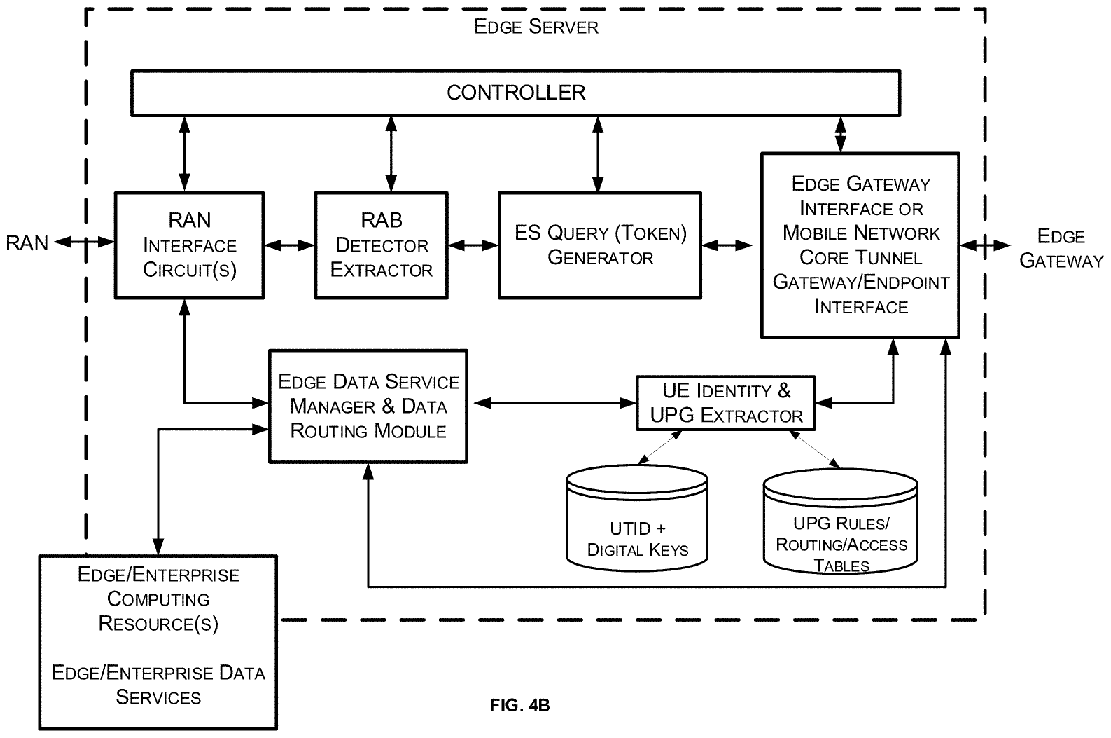

Turning now to FIG. 4A, there is shown a functional block diagram including functional block of an exemplary edge gate according to embodiments of the present invention. The EG includes interface to the network core and to the network edge segment(s). The EG includes elements to correlated RAB information in a received query with a UE identifier, lookup tables to associate UE identifiers with UTID's and UPG membership/affiliation table to determine which group(s) an identified UE is part of. The EG includes a response generator to provide query responses to UE identification queries in accordance with embodiments of the present invention.

FIG. 4B is a functional block diagram of including functional block of an exemplary edge server according to embodiments of the present invention. The edge server of FIG. 4B includes interfaces to the Edge Gateway and to the RAN. It includes a RAB detector and UE identification query generator. The Edge server include an UE identifier and or EU group affiliating information extractor to extract UE related information received via a query response from EG. The edge server includes a data store for associating UE group membership with edge routing policies and or edge data service access policies. The edge server includes a data store for associating UE identifiers with edge routing policies and or edge data service access policies. The SE includes or is functionally associated with a Edge data service manager and or an edge data routing module, configures to perform in UE specific manner for data from each specific UE in accordance with corresponding policies stored in the data store.

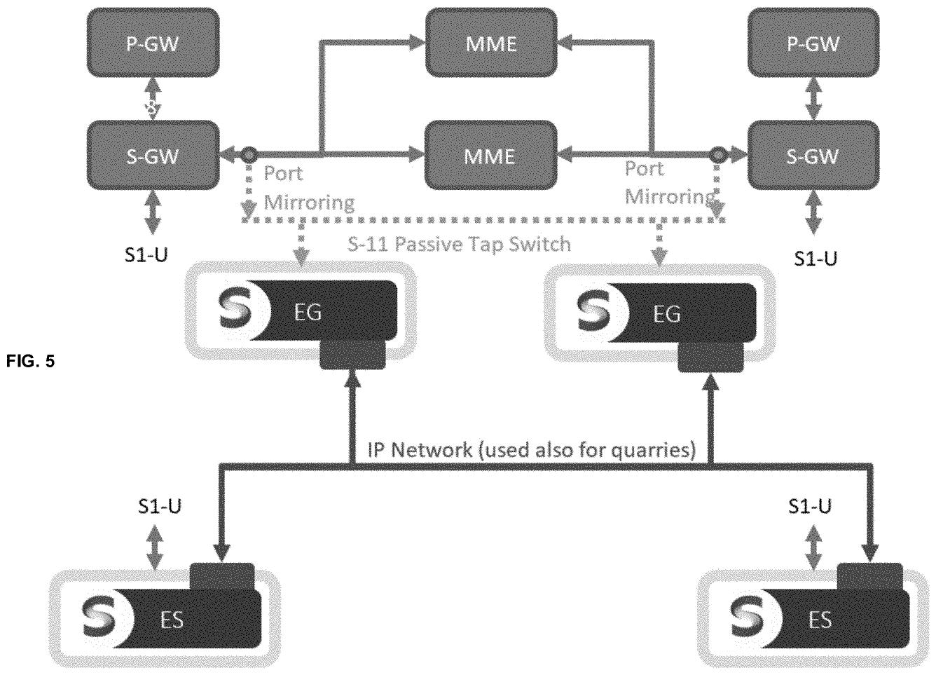

Turning now to FIG. 5, there is shown a functional block diagram of an exemplary network according to embodiments of the present invention with redundancy built in both the network core and network edge segments using port mirroring and switching. The figure illustrates a exemplary deployment, including redundancy, for a general LTE network. According to an Enterprise implementation, the ES may be on premises and fully controlled by the enterprise itself, thus enabling full control over the traffic per each user on premises. The UTID & UPG concept enables full control over authorization per user & user-group on a per session/service basis. Control on a group basis may be done by defining ranges of UPG numbers per enterprise or per specific group inside an enterprise.

Functions, operations, components and/or features described herein with reference to one or more embodiments, may be combined or otherwise utilized with one or more other functions, operations, components and/or features described herein with reference to one or more other embodiments, or vice versa. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A communication network comprising:
at least one network core with one or more network elements to perform each of one or more network management functions, including to manage wireless communication device (User Equipment—UE) related information;
at least one network edge segment integral of otherwise functionally associated with a Radio Access Network portion of said communication network, wherein said edge at least one edge segment includes: (a) one or more wireless access nodes to which a UE associated with the network can communicatively couple; and (b) at least one edge computing resource to provide one or more edge data services to a communicatively coupled UE; and
a network edge gateway between said network core and said network edge segment and including a tokenizer to generate, using UE specific information, a UE specific token and to send the UE specific token to the at least one edge computing resource.

2. The communication network according to claim 1, wherein said at least one edge computing resource includes an edge server to manage data routing between a UE connected to said wireless access nodes, one or more edge data services and said network core.

3. The communication network according to claim 2, wherein said edge server adjusts data routing for a given UE connected to an associated wireless network access node responsive to user permissions group (UPG) data contained in a token associated with the UE.

4. The communication network according to claim 3, wherein said edge server further includes a data routing module which routes data for a given UE connected to an associated wireless network access node, either to said network core or to specific edge data services, responsive to user permissions group (UPG) data contained in a token associated with the given UE.

5. The communication network according to claim 3, wherein said edge server includes: (a) a Radio Access Bearer (RAB) detector which captures a RAB identifier associated with a UE that connected to a wireless network access node; and (b) a query generator to send a UE token request said edge gateway based on the captured RAB identifier to.

6. The communication network according to claim 2, wherein said Edge Server includes an Edge Data Service Manager to activate, configure or deny edge data services for a given UE connected to a wireless access node of said network based either on UPG data or a unique identifier of the UE extracted from a token associated with the UE.

7. The communication network according to claim 6, wherein said Edge Data Service Manager is adapted to pass the UPG and UE identifier data for the given UE to one or more edge data services.

8. The communication network according to claim 7, wherein said one or more edge data services are adapted to adjust services provided to a given UE based on UPG or on UE identifier data received for the given UE.

9. The communication network according to claim 1, wherein a UE specific token for a given UE includes, or is otherwise associated with, an universal traceable identifier (UTID) which enables an edge data service running on the at least one edge computing resource to determine identification information related to an account of the given UE.

10. The communication network according to claim 1, wherein the UE specific token for a given UE includes user permission group (UPG) information relating to an account associated with the given UE and is usable by an edge data service running on the at least one edge computing resource to activate, configure or deny data service to the given UE.

11. The communication network according to claim 1, wherein said tokenizer generates a UE specific token for a given UE when the UE communicatively couples to a wireless access node of a network edge segment and a Radio Access Bearer (RAB) is initiated.

12. The communication network according to claim 11, wherein said tokenizer generates a token responsive to receiving a query from an edge server, wherein the query includes a Fully Qualified Tunnel Endpoint Identifier (F-TEID) allocated to the given UE upon RAB initiation.

13. The communication network according to claim 12, wherein the user specific token includes identification of one or more public IP addressed allocated to the given EU by a network core element.

14. The communication network according to claim 1, wherein two or more edge data services use a UE specific token associated with a given UE to coordinate services provided to the given UE.

15. The communication network according to claim 14, wherein one of the edge data services is a group attributes table which stores data routing policies to apply for UE associated with specific user groups.
